(19) United States
(12) Patent Application Publication
(10) Pub. No.: US 2008/0097262 A1
(43) Pub. Date: Apr. 24, 2008

(54) Massage Apparatus and Method

(76) Inventor: Darrell Adams, Newnan, GA (US)

Correspondence Address: McKinney Law, LLC, 390 N. Orange Avenue, Suite 2300, Orlando, FL, 32801, US

(21) Appl. No.: 11/874,792

(22) Filed: Oct. 18, 2007

Related U.S. Application Data
(60) Provisional application No. 60/852,722, filed on Oct. 19, 2006.

(51) Int. Cl. A61H 7/00

(52) U.S. Cl. 601/134

(57) ABSTRACT

A massage apparatus having an upper vertical post slidably adjustable over a lower vertical post. A number of massage appliances are secured to the upper post. The upper post is rotatably supported by the lower post so that the massage appliances can be rotated in position and accessed by a user. The appliances are orientated on the upper post to specifically massage a desired area of the user's body as the user maintains an upright position. The user selects a desired appliance and rotates it into position. The user then moves closer to the selected massage appliance to apply pressure and also simultaneously moves in a massaging motion. The massage appliances include an elongated vertical member, a downward facing crescent member, a bow tie shaped member, a pair of vertical cylinders, a half sphere member. Each massage appliance is designed to massage a specific area of the user's body.

### CROSS-REFERENCED TO RELATED APPLICATIONS

This application claims the benefit of U.S. Provisional Application No. 60/852,722 filed Oct. 19, 2006. The disclosure of the provisional application is incorporated herein by reference.

### BACKGROUND OF THE INVENTION

1. Field of the Invention

This invention relates generally to a massage apparatus and more specifically to an apparatus that is used for user-directed deep tissue massage.

2. Description of the Prior Art

There are a number of prior art massage devices that are directed to massaging a user's body. By way of example, note U.S. Pat. No. 5,348,529 to Veltri that describes a rocking chair that incorporates rollers into the back portion of the chair. As a user rocks back and forth, the rollers are moved up and down along the user's back. However, the area of massage is limited and method of massage is limited to the rollers.

Another example is U.S. Pat. No. 4,748,972 to Hasgawa that describes a massage device incorporated into a vehicle seat back. The device includes a motor that rotates at a high speed generating vibrations that massage a user's back. However, a shortcoming is that the area of treatment is limited and the method of massage is also limited.

Another example is U.S. Pat. No. 4,777,940 to Yamasaki that describes a portable massage apparatus having a pair of massaging balls that rotate. Again, the massage method is limited and not adaptable to different parts of a user's body for massage treatment.

Notwithstanding the existence of such prior art massage devices, there is a need for an improved massage apparatus. Accordingly, what is needed in the art is a massage apparatus having the ability to massage many different parts of a user's body and also having the ability to perform different methods of massage.

It is, therefore, to the effective resolution of the aforementioned problems and shortcomings of the prior art that the present invention is directed.

However, in view of the prior art at the time the present invention was made, it was not obvious to those of ordinary skill in the pertinent art how the identified needs could be fulfilled.

### SUMMARY OF THE INVENTION

This invention is a massage apparatus including an upper portion having a vertical post slidably adjustable over a lower vertical post having a smaller diameter than upper post. The lower post further comprising an adjustable friction pin that allows upper post to be slidably adjustable in the vertical position depending on a user's height. The upper post further comprising a plurality of different appliances to provide massage treatment to various areas of a user's body. A lower portion of the massage apparatus comprises a plurality of legs that are attached at a first end to the lower post and form a non-skid base. Each leg further comprising a planar flange that provides additional support to the massage apparatus. The apparatus is adaptable to be mounted in a corner and not free standing as an alternative embodiment.

In use, a user selects the desired appliance and rotates it into position. The height of the appliance is adjusted vertically so that it is at the proper orientation to massage the desired area of the user's body. Next the user moves closer to the selected appliance and increases the pressure exerted by the appliance until a desired amount of pressure is attained to the specific area of the user's body. The user simultaneously moves in a massaging pattern as the desired appliance remains stationary so that the desired area of the user's body receives the massage treatment.

It is therefore an object of the present invention to provide for an improvement that overcomes the aforementioned inadequacies of the prior art and provides a significant contribution to the advancement of massage devices.

Another object of the present invention is to provide a massage apparatus having the ability to massage different parts of a user's body.

Another object of the present invention is to provide a massage apparatus having the ability to perform different types of deep tissue massage treatment.

Both the foregoing general description and the following detailed description are explanatory and are not restrictive of the invention as claimed. The accompanying drawings, which are incorporated in and constitute part of the specification, illustrate embodiments of the present invention and together with the general description, serve to explain principles of the present invention.

These and other important objects, advantages, and features of the invention will become clear as this description proceeds.

The invention accordingly comprises the features of construction, combination of elements, and arrangement of parts that will be exemplified in the description set forth hereinafter and the scope of the invention will be indicated in the claims.

### BRIEF DESCRIPTION OF THE DRAWINGS

For a fuller understanding of the nature and objects of the invention, reference should be made to the following detailed description, taken in connection with the accompanying drawings, in which:

FIG. 1 is a perspective view showing an embodiment of the present invention;

FIG. 2 is a perspective view showing an elongated vertical appliance in use by a user of an embodiment of the present invention;

FIG. 3 is a perspective view showing a downward facing crescent appliance in use by a user of an embodiment of the present invention;

FIG. 4 is a perspective view showing a bow-tie shaped appliance in use by a user of an embodiment of the present invention;

FIG. 5 is a perspective view showing a dual vertical cylinder appliance in use by a user of an embodiment of the present invention; and

FIG. 6 is a perspective view showing a half-sphere appliance in use by a user of an embodiment of the present invention.

### DETAILED DESCRIPTION OF THE PREFERRED EMBODIMENT

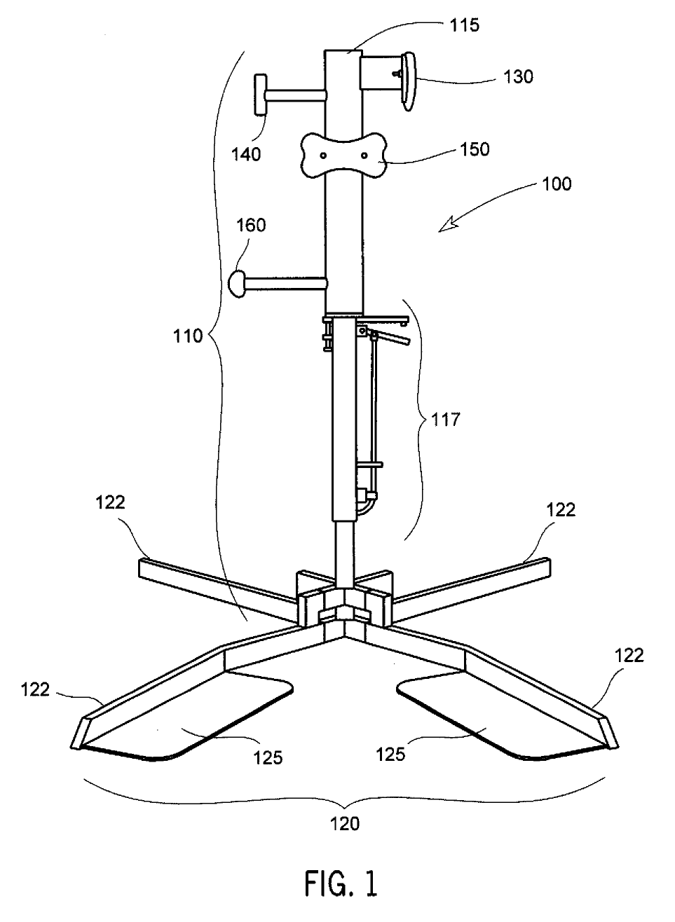

Referring to FIG. 1 shows massage apparatus 100 of the present invention. This invention is comprised of an upper portion 110 having a vertical post 115 slidably adjustable over a lower vertical post 117 having a smaller diameter than upper post 115. Lower post 117 further comprises an adjustable device that allows upper post 115 to be slidably adjustable in the vertical position depending on a user's height and is rotatably adjustable in 360 degrees. A friction pin secured the upper post at the desired height and position. A spring means (not shown) is disposed between the upper post 115 and lower post 117 to allow easy vertical height adjustment. Upper post 115 further comprises five different appliances 130, 140, 150, 160, 170. A lower portion 120 of the massage apparatus 100 comprises four legs 122 that are attached at a first end to the lower post 117. The legs 122 further comprise a planar flange 125 that provides additional support to the massage apparatus 100.

To use the apparatus 100, a user 200 will step onto the non-slip platform (not shown) at the front of the apparatus 100 and rotate upper post 115 to the desired appliance. After selecting the desired appliance, the user 200 leans against the appliance exerting the exact amount of pressure in the exact area and direction a user 200 desires to massage and moves in a massaging pattern. Due to the novel features of the massage apparatus 100, the weight of the upper torso of a user 200 pressed against the relatively small appliances requires a minimum amount of effort and movement to achieve a sufficiently deep massage. The apparatus can treat all affected all muscles of the user's 200 back with relative ease allowing a user 200 to relax while simply leaning against the apparatus 100.

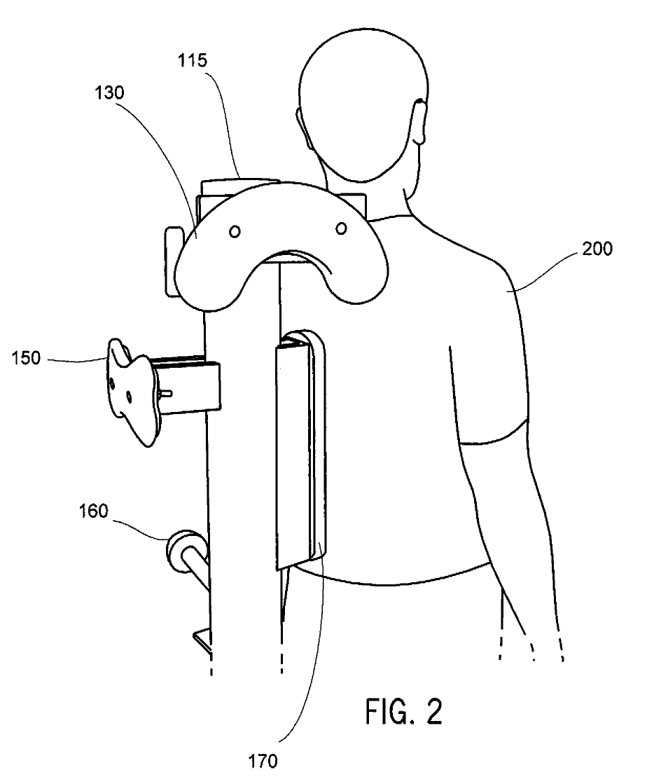

Referring now to FIG. 2, an elongated vertical appliance 170 is shown being applied to a user's 200 muscles of the mid to upper back next to the spine and outwardly to the scapula. As user stands upright and adjacent to apparatus 100, the user 200 leans against vertical appliance 170. The user 200 determines the amount of pressure to apply and also the specific location and area to perform the massage treatment as user 200 simultaneously moves his or her torso in a circular massaging motion.

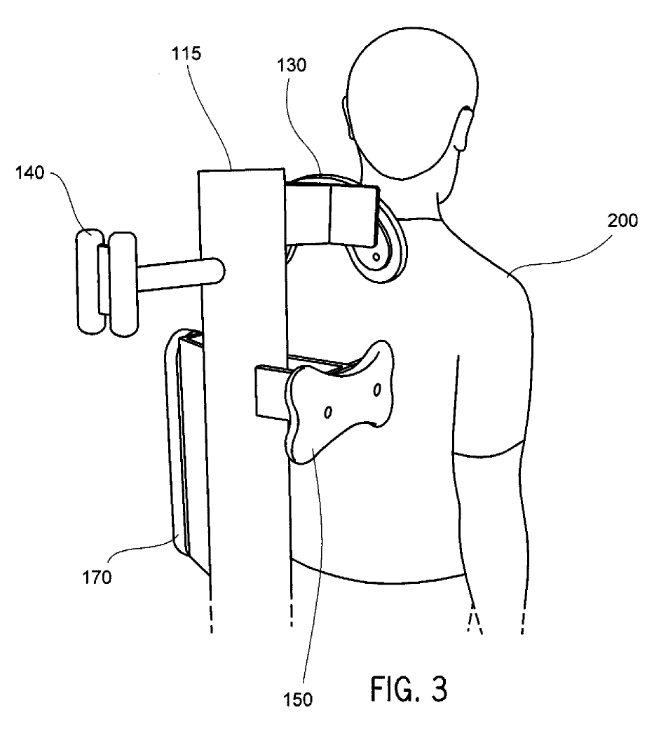

Referring now to FIG. 3, a downward facing crescent appliance 130 is used to treat the user's 200 neck and upper trapezium muscle. Again, the user 200 stands adjacent to apparatus 100 and applies the appropriate amount of pressure for the massage treatment as apparatus 100 remains stationary and providing resistance to user 200.

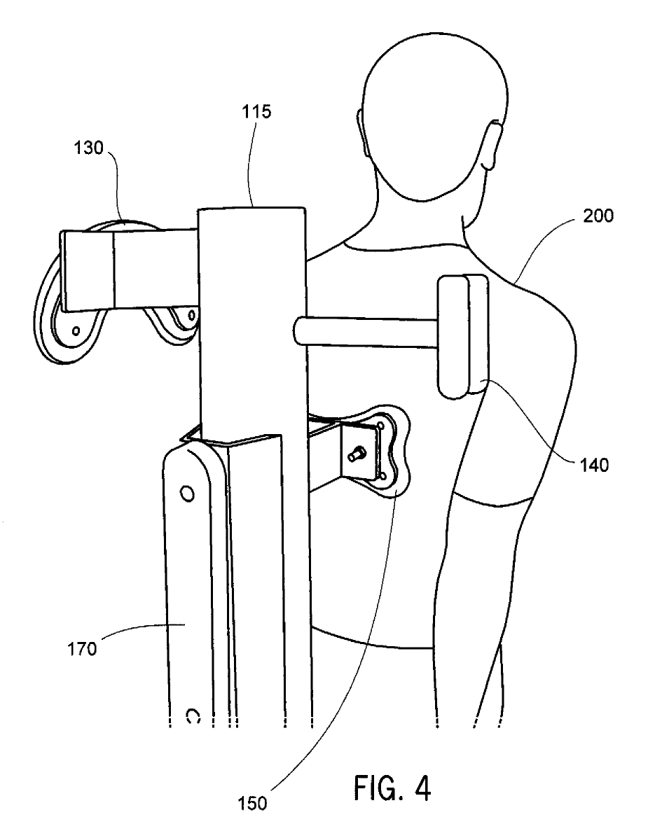

Referring now to FIG. 4, a bow tie shaped appliance 150 is used to treat the user's musculature above and beneath the scapula and above and below it in a vertical direction. Bow tie shaped appliance 150 is also used treat the rear of the deltoid and the latissimus dori of a user. The user 200 stands proximate to upper post 115 and applies pressure to the desired area by leaning slightly into appliance 150. As the user 200 finds the desired location to apply the massage treatment the user 200 can work the area in a gentle circular massaging motion to provide immediate relief.

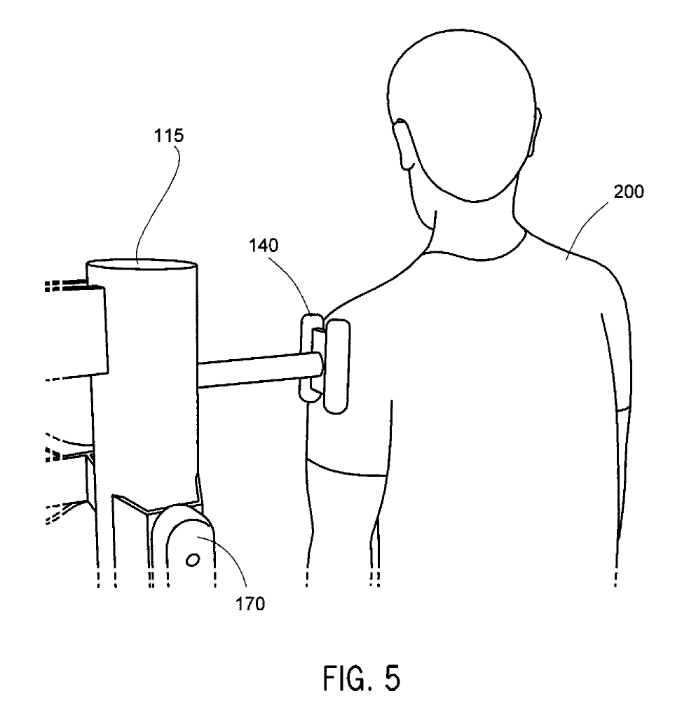

As shown in FIG. 5, a dual vertical cylinder 140 is used to massage the shoulder and deltoid muscle area of a user 200. As with all the appliances 130, 140, 150, 160, 170, the proper height of appliance 140 can be adjusted by slidably moving the upper post 115 up or down over lower post 117.

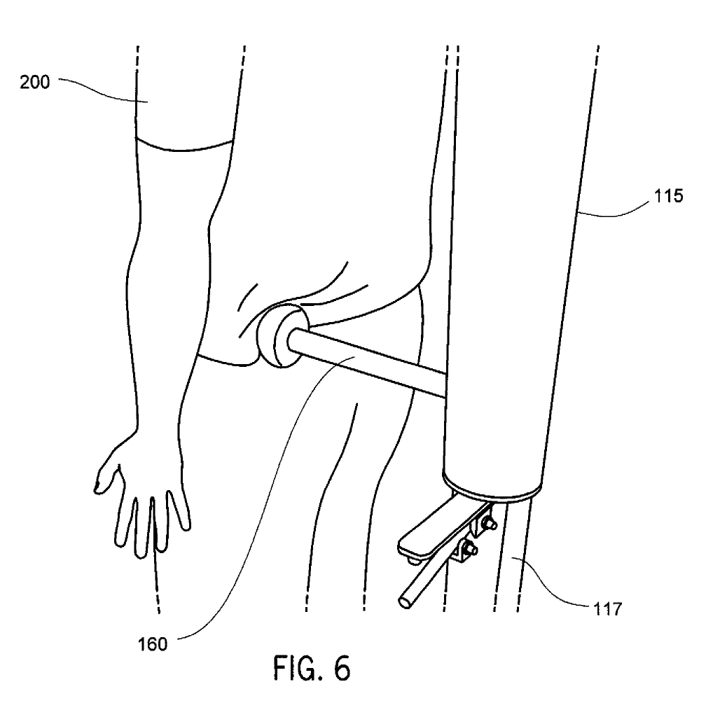

Referring now to FIG. 6, a half sphere appliance 160 is used to treat the lower back and external oblique area of a user 200 using the same method of leaning gently against appliance 160 and moving gently in a circular massaging motion.

The particular embodiments disclosed above and in the drawings are illustrative only, as the invention may be modified and practiced in different but equivalent manners apparent to those skilled in the art having the benefit of the teachings herein. Furthermore, no limitations are intended to the details of construction or design herein shown. It is therefore evident that the particular embodiments disclosed above may be altered or modified and all such variations are considered within the scope and spirit of the invention.

It is also to be understood that the following claims are intended to cover all of the generic and specific features of the invention herein described, and all statements of the scope of the invention, which as a matter of language, might be said to fall there between.

Now that the invention has been described,

What is claimed is:

1. A massage apparatus comprising:
an upper vertical post slidably adjustable over a lower vertical post having a smaller diameter than the upper post; wherein the lower post further comprising an adjustable friction pin to secure the upper vertical post at a desired height;
a spring interposed between the upper post and the lower post facilitates sliding the upper post to the desired height;
the upper post further comprising a plurality of stationary appliances for performing massage; and
a plurality of legs equidistantly spaced and secured to a first end of the lower post wherein each leg further comprising a perpendicular planar flange to support the massage apparatus.

2. The massage apparatus of claim 1 wherein a first appliance of the plurality of appliances comprising an elongated vertical member secured to the upper post and disposed thereon at an orientation and height compatible to massage a user's muscles of the mid to upper back next to the spine and outwardly to the scapula as the user maintains an upright position.

3. The massage apparatus of claim 2 wherein a second appliance of the plurality of appliances comprising a downward facing crescent member secured to the upper post and disposed thereon at an orientation and height compatible to massage a user's neck and upper trapezium muscle as the user maintains an upright position.

4. The massage apparatus of claim 3 wherein a third appliance of the plurality of appliances comprising a bow tie shaped member secured to the upper post and disposed thereon at an orientation and height compatible to massage a user's musculature above and beneath the scapula and above and below it in a vertical direction and the rear of the deltoid and the latissimus dori as the user maintains an upright position.

5. The massage apparatus of claim 4 wherein a fourth appliance of the plurality of appliances comprising a pair of vertical cylinders secured to the upper post and disposed thereon at an orientation and height compatible to massage a user's shoulder and deltoid muscle as the user maintains an upright position.

6. The massage apparatus of claim 5 wherein a fifth appliance of the plurality of appliances comprising a half sphere member secured to the upper post and disposed thereon at an orientation and height compatible to massage a user's muscles of the lower back and external oblique area as the user maintains an upright position.

7. The massage apparatus of claim 1 wherein the upper post is rotatably supported by the lower post so that the selected appliance of the plurality of appliances is accessible to the user and disposed thereon at an orientation and height compatible to massage a desired area of a user's body as the user maintains an upright position.

8. A massage apparatus comprising:
an upper vertical post slidably adjustable over a lower vertical post having a smaller diameter than the upper post; wherein the upper post is rotatably supported by the lower post so that a plurality of stationary appliances are accessible to the user and the plurality of appliances disposed thereon at an orientation and height compatible to massage a desired area of a user's body as the user maintains an upright position and the lower post further comprising an adjustable friction pin to secure the upper vertical post at a desired height;
a spring interposed between the upper post and the lower post facilitates sliding the upper post to the desired height;
a first appliance of the plurality of appliances comprising an elongated vertical member secured to the upper post and disposed thereon at an orientation and height compatible to massage a user's muscles of the mid to upper back next to the spine and outwardly to the scapula as the user maintains an upright position; a second appliance of the plurality of appliances comprising a downward facing crescent member secured to the upper post and disposed thereon at an orientation and height compatible to massage a user's neck and upper trapezium muscle as the user maintains an upright position; a third appliance of the plurality of appliances comprising a bow tie shaped member secured to the upper post and disposed thereon at an orientation and height compatible to massage a user's musculature above and beneath the scapula and above and below it in a vertical direction and the rear of the deltoid and the latissimus dori as the user maintains an upright position; a fourth appliance of the plurality of appliances comprising a pair of vertical cylinders secured to the upper post and disposed thereon at an adjustable orientation and height compatible to massage a user's shoulder and deltoid muscle as the user maintains an upright position; a fifth appliance of the plurality of appliances comprising a half sphere member secured to the upper post and disposed thereon at an orientation and height compatible to massage a user's muscles of the lower back and external oblique area as the user maintains an upright position; and
a plurality of legs equidistantly spaced and secured to a first end of the lower post wherein each leg further comprising a perpendicular planar flange to support the massage apparatus.

9. A method of applying a massage while a user maintains an upright position using a massage apparatus, the method comprising:
providing a plurality of stationary appliances for performing massage which are disposed on the massage apparatus at an adjustable orientation and height compatible to massage a desired area of a user's body as the user maintains an upright position;
selecting a desired appliance from the plurality of appliances;
rotating the desired appliance to a proper orientation to perform a massage to the desired area of the user's body;
adjusting the height of the desired appliance to perform a massage to the desired area of the user's body;
increasing pressure exerted by the desired appliance by the user moving toward the desired appliance until a desired amount of pressure is attained to the desired area of the user's body; and
moving the user in a massaging pattern as the desired appliance remains stationary so that the desired area of the user's body receives the massage treatment.

10. The method of claim 9 wherein the desired appliance is an elongated vertical member adaptable to massage the user's muscles of the mid to upper back next to the spine and outwardly to the scapula as the user maintains an upright position.

11. The method of claim 9 wherein the desired appliance is a downward facing crescent member adaptable to massage the user's neck and upper trapezium muscle as the user maintains an upright position.

12. The method of claim 9 wherein the desired appliance is a bow tie shaped member adaptable to massage the user's musculature above and beneath the scapula and above and below it in a vertical direction and the rear of the deltoid and the latissimus dori as the user maintains an upright position.

13. The method of claim 9 wherein the desired appliance is a pair of vertical cylinders adaptable to massage the user's shoulder and deltoid muscle as the user maintains an upright position.

14. The method of claim 9 wherein the desired appliance is a half sphere member adaptable to massage the user's muscles of the lower back and external oblique area as the user maintains an upright position.
